(19) United States
(12) Patent Application Publication
(10) Pub. No.: US 2002/0103698 A1
(43) Pub. Date: Aug. 1, 2002

(54) System and method for enabling user control of online advertising campaigns

(76) Inventor: Christian Cantrell, Reston, VA (US)

Correspondence Address: COOLEY GODWARD LLP, ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 09/726,422

(22) Filed: Dec. 1, 2000

Related U.S. Application Data
(60) Provisional application No. 60/244,207, filed on Oct. 31, 2000.

(51) Int. Cl. G06F 17/60

(52) U.S. Cl. 705/14; 707/513; 707/517

(57) ABSTRACT

A system and method for enabling user control over the creation and deployment of banner ad campaigns is disclosed. Through a web-browser interface, an advertiser can control the creation and implementation of an online advertising campaign (e.g., banner ad campaign). In particular, an advertiser can control various advertising campaign functions, including the design of a banner ad, the selection of an advertising channel in which the created banner ad will be displayed, the monitoring of the effectiveness of the banner advertising campaign, and the redesign and redeployment of the banner ad.

The present application claims priority to Provisional Application No. 60/244,207, filed Oct. 31, 2000, which is incorporated herein by reference in its entirety.

### BACKGROUND

1. Field of the Invention

The present invention relates generally to online advertising systems and methods, and more particularly, to systems and methods for enabling user control of the design and deployment of online advertising campaigns.

2. Discussion of the Related Art

The attraction of the Internet media to the general population is causing a significant shift in the traditional channels of advertisement. Traditional media such as television, magazines, and newspapers are quickly losing significant “eye-share” to the growing online phenomenon. Users now view the world wide web (WWW) as a primary source of news and general information content. Indeed, many hard-copy subscriptions to magazines and newspapers are being replaced by comparable subscriptions to the respective online versions.

Online advertising has therefore played an increasingly prominent role in the expanding exposure of users to Internet service providers (ISPs) and the WWW. Banner advertisements in particular have risen to prominence as the primary advertising vehicle on the WWW. Banner advertisements typically appear on a reserved portion (e.g., top or bottom) of a web page that is rendered by a web browser. The particular banner advertisement on a web page enables a user to reach the advertiser's web site by “clicking-through” the banner ad. The click-through rate is one of the primary vehicles for determining advertising fees.

Banner ad design and placement typically involves a third party. With respect to the design phase, a third-party designer will play a role similar to an advertising agency that designs commercials or print advertisements. Taking, as input, the goals and general objectives of a potential advertiser, the third-party designer generates a banner ad design that it believes will generate the most interest among the viewing public. After the banner ad design has been completed and approved by the advertiser, the banner ad is then delivered to the banner ad serving agency that will deliver the banner ad to its network of affiliates.

The effectiveness of a banner ad campaign can be measured in various ways. For example, the effectiveness of the banner ad campaign can be evaluated based upon a click-through rate. Regardless of the measure of advertising effectiveness used by the advertiser and ad serving agency, a redesign of the banner ad campaign may be required at some point.

In this process, the banner ad campaign is halted and the third party ad designer reviews the content and style of the banner ad and makes whatever changes it considers appropriate. Once the advertiser approves the modifications, the revised banner ad is then submitted to the banner ad serving agency for redeployment. This banner ad deployment and redeployment process incurs significant expense and delays. The delays are particularly problematic when considering the overall goal of maintaining and generating the maximal level of impact over a short period of time.

As is well known, the viewing Internet public can quickly be desensitized to a banner ad campaign that has previously been seen. Accordingly, what is needed is an efficient mechanism for deploying and redeploying banner ads on an online network. In particular, what is needed is a mechanism that enables an advertiser to exhibit greater control over the banner ad design and placement process. In this manner, an advertiser can ensure that the advertising campaign will not suffer from unnecessary delays that are incurred through the intervention of third parties.

### SUMMARY OF THE INVENTION

The present invention addresses the drawbacks of conventional ad delivery environments by providing a system and method that enable an advertiser to control the creation and implementation of an online advertising campaign. This control is effected through the interaction by an advertiser with a user interface that is rendered by a user workstation. In a preferred embodiment, the user interface is web-browser based and is generated in accordance with user-interface web page data that is transmitted by a server associated with an ad serving entity.

The user interface enables an advertiser to control various advertising campaign functions, including the creation of an online ad, the selection of an advertising channel in which the created online ad will be displayed, the monitoring of the effectiveness of the online advertising campaign, and the redesign and redeployment of the online ad.

### BRIEF DESCRIPTION OF THE DRAWINGS

The foregoing and other features and advantages of the invention will be apparent from the following, more particular description of a preferred embodiment of the invention, as illustrated in the accompanying drawings.

FIG. 1 illustrates a generic banner ad delivery network

FIGS. 2A-2C illustrate a collection of scenes in a banner ad.

FIGS. 3A and 3B illustrate the transitions between states in the operation of a banner ad.

FIG. 4 illustrates a user interface for providing an ad campaign listing.

FIG. 5 illustrates a user interface for providing a banner ad overview.

FIG. 6 illustrates a user interface for creating a loading scene.

FIG. 7 illustrates a user interface for creating a hover scene.

FIG. 8 illustrates a user interface for providing a catalogue slide overview.

FIGS. 9A and 9B illustrate a user interface for creating a purchasable slide.

FIG. 10 illustrates a product order/info pop-up window.

FIG. 11 illustrates a user interface for specifying a scene change effect between slides in a banner ad.

FIG. 12 illustrates a user interface for selecting channels for a banner ad campaign.

FIG. 13 illustrates a channel cart user interface.

FIG. 14 is a flowchart of a banner ad yield management process.

FIG. 15 illustrates a viral marketing mechanism within a banner ad.

FIGS. 16, 17A-17C, and 18-21 illustrate user interfaces for the creation and delivery of online ads.

### DETAILED DESCRIPTION

A preferred embodiment of the invention is discussed in detail below. While specific implementations are discussed, it should be understood that this is done for illustration purposes only. A person skilled in the relevant art will recognize that other components and configurations may be used without parting from the spirit and scope of the invention.

Banner advertisements represent one of the primary vehicles for web site operators to extract revenue based upon the traffic at their own web site. In the early stages of online advertising on the Internet, advertising revenue was based simply upon the number of banner ad impressions. As the number of banner ad impressions were proportional to the number of users that would visit a web site, web site operators sought to rapidly acquire and create a community of users that would frequent their web site. In this environment, the sheer weight of a web site's community of users formed the basis of a significant advertising revenue stream.

As Internet users have become increasingly familiar with the concept of banner ads, they have also become increasingly unresponsive. Banner ads have become an expected element of the Internet experience and are often ignored. For this reason, banner ad designers have continued to innovate to try and attract the attention of the Internet public. For example, while early banner ads were largely comprised of single image graphic files (e.g., GIF files), more recent banner ads have utilized a greater degree of animation using animated GIF files. All of these innovations have simply sought to attract the attention of a user that is inclined to ignore that area of the rendered web page. A general limitation of banner ads that use GIF images is that the user who responds to the banner ad by clicking on it will leave the web site the user was visiting.

In the evolution of the banner ad, greater emphasis has been placed on the content of the banner ad and the corresponding responsiveness of the viewing audience. Increasingly, the responsiveness of the audience dictates the advertising revenue to be generated. Rather than being based upon an impression basis, the advertising revenue can be based upon the click-through rate or any other corresponding measure of user interactivity with the banner ad.

The present invention is primarily directed to mechanisms that enable advertisers to maximize the performance of their online advertising campaign. One feature of the present invention is the provision of a user-controlled online ad creation and deployment mechanism that enables an advertiser to place user-interactive online ads on an ad-serving network. In one embodiment, the user-interactive online ads enable an advertiser to provide full e-commerce functionality within the online ad itself. In the following description, a specific example of online advertising (i.e., banner advertising) is discussed. It should be recognized that the concepts described below are not restricted to banner ads but are extensible to a generic form of online advertising. Prior to discussing the features of the present invention, a brief description of a generic banner ad delivery network is first provided.

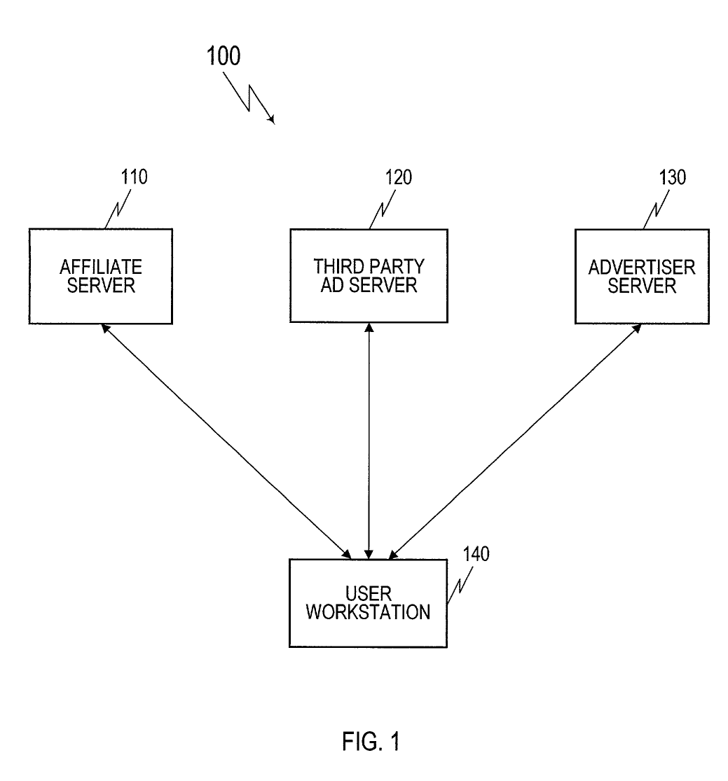

FIG. 1 illustrates a generic banner ad delivery network 100. Banner ad delivery network 100 comprises affiliate server 110, third party ad server 120, advertiser server 130, and user workstation 140. Generally, an affiliate is an entity that permits third party advertisements to be displayed on their web sites. When user workstation 140, through a web-browser interface, downloads a web page from affiliate server 110, an advertisement provided by the third party ad server 120 is overlaid onto the display of the affiliate's web page. It should be noted that the advertisement can be provided directly by third party ad server 120 or can be provided by another ad server (not shown) that receives a banner ad request that has been redirected by third party ad server 120. In the following description, the term third party ad server is used to refer to any source of advertising content, whether or not that source of advertising content was the original recipient of an advertising content request. After the banner ad is displayed on a reserved portion of the affiliate's web page, the user can connect to advertiser server 130 by clicking through or otherwise selecting the advertisement (e.g., image, icon, etc.).

More particularly, the operation of banner ad delivery network 100 begins when user workstation 140 contacts affiliate server 110 by generating a hypertext transfer protocol (HTTP) message to get the information for the desired web page. Affiliate server 110 then responds by transmitting web page information, such as a compilation of hypertext markup language (HTML) code, JavaScript, Java applets, graphic image files (e.g., GIF, JPEG), etc., that is used by user workstation 140 in rendering the requested web page in the user's web browser interface.

As part of this compilation of web page information, affiliate server 110 also sends a tag (e.g., applet tag) that identifies the source of the banner ad. Using the received tag, user workstation 140 can then send a message to third party ad server 120 to request the banner ad to be inserted into the web page. As noted above, this request may be redirected to yet another third party ad server. As part of this banner ad request, user workstation 140 can also send information, such as information that identifies the web site, location in the web site, location in the web page where the advertisement is to be displayed, user identification, etc., that third party ad server 120 can use to determine which banner ad to send to user workstation 140.

Upon receiving the request by user workstation 140, third party ad server 120 determines which advertisement to provide to user workstation 140. Once identified, the advertisement is transmitted to user workstation 140 and overlaid onto the web page that is been rendered by user workstation 140 in the web browser interface.

As noted, one of the drawbacks of conventional ad delivery environments is the delays and expense that are incurred in the design and redesign of a banner ad that is ready to be delivered by third party ad server 120 to a user workstation 140. This design process involves extensive use of third parties that are not immediately responsive to the advertiser. This lack of control is a significant detriment to the advertiser in the creation of an effective advertising campaign.

The present invention addresses this issue by providing a system and method that enables an advertiser to directly control all phases of the creation and implementation of a banner advertising campaign. This control is effected through the interaction by an advertiser with a user interface that is rendered by user workstation 140. In a preferred embodiment, the user interface is web-browser based and is generated in accordance with user-interface web page data (e.g., HTML, JavaScript, Java applets, etc.) that is transmitted by a server associated with the entity that is responsible for delivering banner ads to requesting user workstations 140.

As will be described in detail below, this user interface enables an advertiser to directly control various advertising campaign functions, including the design of a banner ad, the selection of an advertising channel in which the created banner ad will be displayed, the monitoring of the effectiveness of the banner advertising campaign, and the redesign and redeployment of the banner ad.

In the example user interface described below, an advertiser is capable of designing a banner ad that is dynamic in its appearance and interactivity. As such, the banner ads that are capable of being created by the user interface are superior to conventional static banner ads that comprise one or more image graphic files (e.g., GIFs).

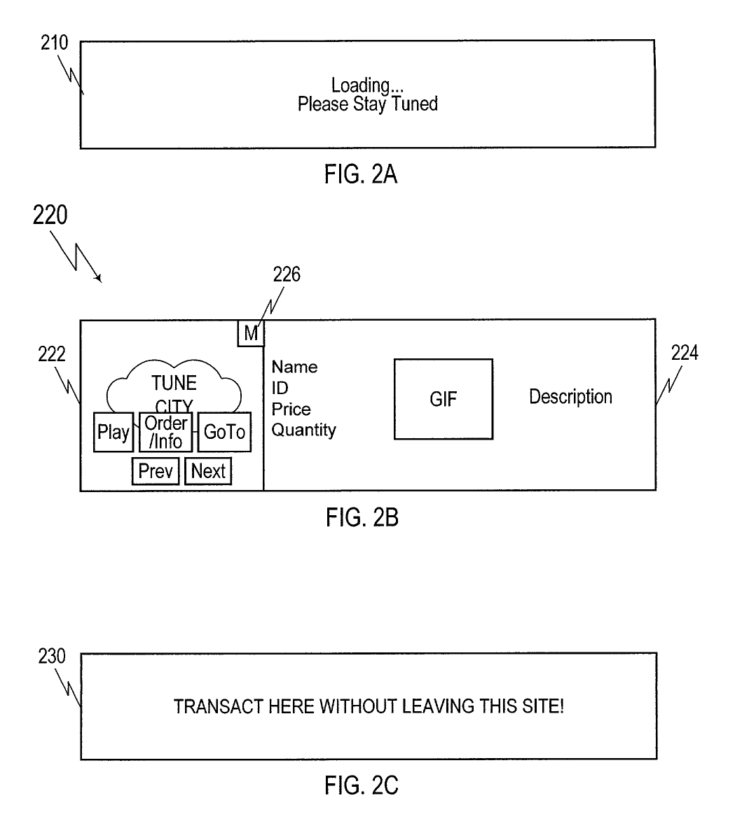

In one embodiment, the banner ads comprise a plurality of scenes including a loading scene, a catalogue menu scene, and an optional hover scene. The loading scene is the first scene that is displayed in the banner ad space and is used to ensure that a message is displayed while the banner ad is being loaded by user workstation 140. An example of a loading scene 210 is illustrated in FIG. 2A.

The catalogue menu scene sequentially displays a plurality of slides that are defined by the advertiser. An example of a catalogue menu scene 220 is illustrated in FIG. 2B. The catalogue menu scene 220 includes logo display area 222 and slide display area 224. Logo display area 222 includes a company logo, control buttons (Play, Order/Info, GoTo, Prev, Next), and a mysterious icon 226. The function of the control buttons and mysterious icon 226 will be described in greater detail below. Slide display area 224 represents a ticker area that sequentially scrolls through a catalogue of graphic images.

The catalogue of graphic images can be used in a variety of advertising contexts. In one example, the catalogue of graphic images can be used to convey a message, such as a political campaign theme, where each catalogue item displays one element of a candidate's overall political position. In another example, the catalogue of graphic images can be used to advertise a catalogue of products that are for sale. In this example, each graphic image can display a picture of the product along with the product's name, ID, price, quantity, and description. This product catalogue scenario is illustrated in the slide display area 224 of FIG. 2B.

The optional hover scene is displayed in the banner ad space when a user passes a mouse through the banner ad space. An example of a hover scene 230 is illustrated in FIG. 2C. Hover scene 230 can be used to signal to a user that the banner ad is an interactive banner ad. As the banner ad can be designed to complete transactions solely within the banner ad and corresponding pop-up windows, the user can be alerted that interaction with the banner ad will not cause them to leave the currently visited web site. This feature is especially useful in encouraging banner ad interaction by users that are predisposed to ignoring banner ads because of the expected consequence of being hyper-linked away from their current web site location.

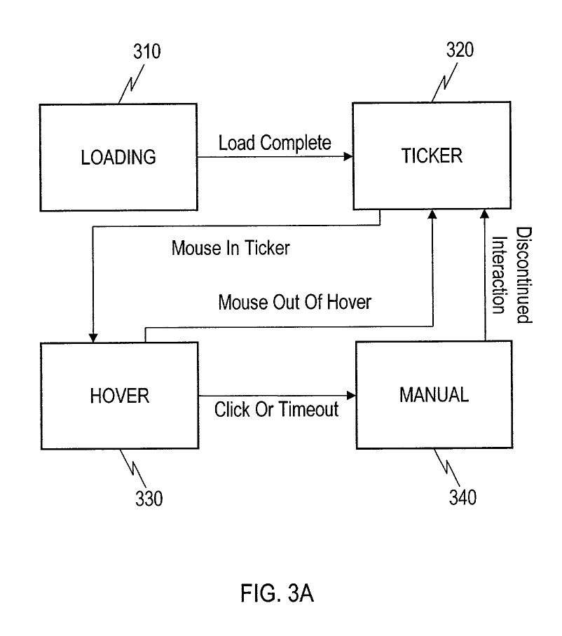

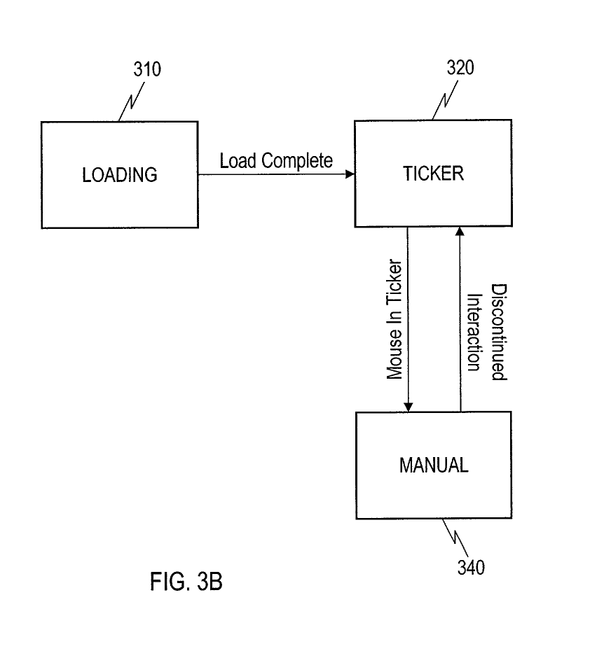

FIGS. 3A and 3B further illustrate the interplay between the loading scene, catalogue menu scene, and the hover scene. FIG. 3A illustrates the scenario where the optional hover scene has been selected by the advertiser. In the state transition diagram of FIG. 3A, the banner ad process begins in loading state 310. In loading state 310, the loading scene is displayed in the banner ad space while the banner ad is being loaded by user workstation 140.

After the banner ad has been loaded by user workstation 140, the banner ad process transitions into ticker state 320. In ticker state 320, an attractor loop is initiated which cycles through a plurality of slides. As noted, these slides are displayed in a slide display area such as that illustrated as display area 224 in catalogue menu scene 220 of FIG. 2B. The attractor loop serves to display a series of messages, advertisements, etc., that would create a measure of interest in the user viewing the web page in which the banner ad is being displayed.

Conventional banner ads typically comprise one or more static graphic images. Their purpose is simply to increase a user's interest to a sufficient degree such that the user will click on the hyperlinked banner ad. Clicking on the banner ad will then take the user to the advertiser's web site.

In the present invention, banner ads can be created that are interactive. In this environment, clicking at a point within the ad space will not necessarily transport a user to another web site. As users are conditioned to expect to be transported to another web site upon a mouse click, they will not necessarily attempt to interact with the banner ad. Accordingly, a hover scene can be used to signal to the user that the banner ad is responsive to the user's actions. More specifically, the java applet can be designed to detect movement of a user's mouse into the banner ad area of the screen and respond by displaying the hover scene in the banner ad space.

An example of a hover scene 230 is illustrated in FIG. 2C. Hover scene 230 is designed to inform the viewing user that interaction with the banner ad will not result in a click-through to an advertiser's web site. Indeed, the appearance of the hover scene upon the movement of the user's mouse into the banner ad space will alert the user that the banner ad is responsive to the user's actions.

With reference to FIG. 3A, the movement of the mouse into the ticker (i.e., into the banner ad space) will cause a state transition from ticker state 320 to hover state 330. While in hover state 330, the user can choose not to interact with banner ad and move the mouse out of the ticker (or banner ad space). This detected action by the Java applet will cause a state transition back to ticker state 320. In other words, if the user decides not to interact with the banner ad, the banner ad will return to displaying the attractor loop.

If the user chooses to interact with the banner ad by clicking in the banner ad space or keeps the mouse in the banner ad space for a predetermined period of time, then a state transition occurs from hover state 330 to manual state 340. In this transition, the catalogue menu scene changes such that the attractor loop can be manually controlled. For example, consider catalogue menu scene 220. In ticker state 320, catalogue menu scene 220 can be designed to display only the logo in logo display area 222, while the attractor loop of slides is being displayed in slide display area 224. In manual state 340, however, logo display area 222 can be designed to display a set of buttons (e.g., Play, Order/Info, GoTo, Prev, and Next) in addition to the logo. These buttons can be used to control the display of slides in a manually-controlled attractor loop. User interactivity with the buttons can be encouraged by highlighting the various buttons on mouse over.

Manual control of the attractor loop enables a user to parse through the catalogue of slides. In a sales context, the user can identify a particular item of interest that is described in a particular slide, gain additional information, and choose whether to purchase the pictured item. If the user discontinues his interaction with the banner ad, then a transition from manual state 340 to ticker state 320 occurs. In this state transition, the banner ad resumes the display of the attractor loop.

FIG. 3B illustrates a state transition diagram in an alternative implementation where the optional hover scene is not selected. In this scenario, the transition between loading state 310 and ticker state 320 is identical to the analogous state transition in FIG. 3A. Unlike FIG. 3A, however, any movement of the mouse into the banner ad space causes a state transition from ticker state 320 to manual state 340. If the user terminates his interaction with the banner ad while in manual mode, then a transition from manual state 340 back to ticker state 320 occurs.

As described, a banner ad that operates in accordance with the state transition diagrams of FIGS. 3A and 3B are feature rich as compared to conventional static banner ads. In a conventional banner ad design process, the inclusion of additional features only serves to delay the introduction and launch of the prospective banner ad campaign.

It is a feature of the present invention that an entire banner ad campaign can be designed, monitored, and redesigned by any individual or entity that desires to advertise on the Internet. This element of control represents a significant advantage over conventional banner ad design and deployment processes.

This control is effected through an individual's or entity's interaction with a user interface that enables the individual or entity to efficiently create and deploy a banner ad campaign. In a preferred embodiment, the user interface is rendered in a web browser environment. The user interface is rendered based upon a compilation of HTML, JavaScript, Java applets, etc. that are received from a server.

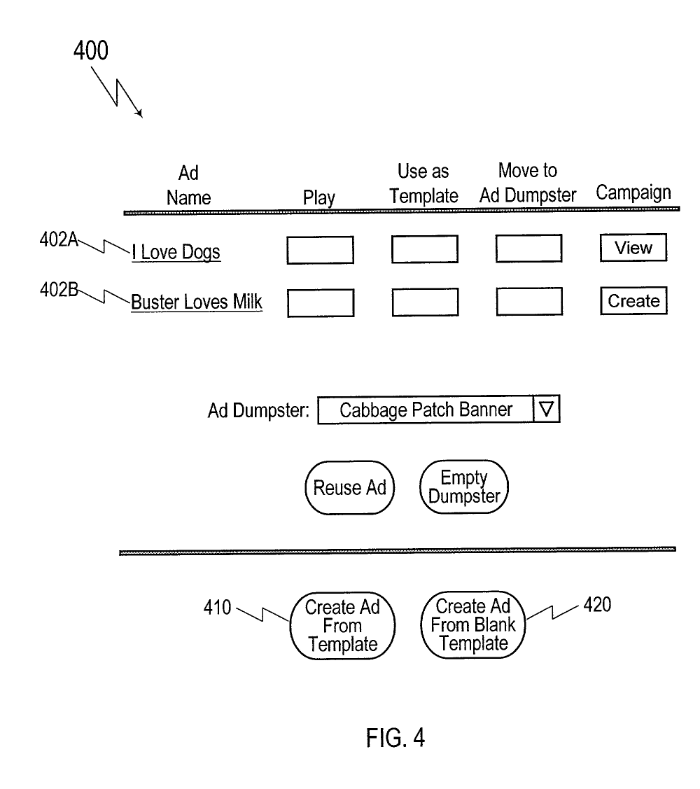

FIG. 4 illustrates an initial ad catalogue listing screen 400 that can be used to define a banner ad campaign. In ad catalogue listing screen 400, a user is presented with a listing of one or more banner ad campaigns that have been at least partially defined. As such, the listing of ad campaigns can include banner ad campaigns in various stages of the lifecycle. For example, the listing can include banner ad designs that have been fully designed and currently deployed, banner ad campaigns that are in the process of being redesigned, banner ad campaigns that are currently being designed, etc.

The listing of ad campaigns enables a user to use existing ad campaign information in the creation of a new ad campaign. In this manner, the banner ad design cycle is greatly reduced. For example, a user can choose to modify a banner ad campaign that was run a few months ago by simply updating one or more slides in the attractor loop. As soon as those modifications are made, the banner ad can be run on the predefined banner advertising channel. The process of designing a banner advertising channel is described in greater detail below.

As illustrated in FIG. 4, ad catalogue listing screen 400 presents a user interface that enables a user to create an ad campaign based upon an ad campaign that is at least partially defined or to create an ad campaign using a blank template. More specifically, ad catalogue listing screen 400 presents a table having a plurality of rows 402A-402B, wherein each row is associated with an individual banner ad campaign. Within each row 402A-402B, the user is presented with options that enable the user to play the banner ad (i.e., review all elements of the banner ad as it will be viewed on a website), use the banner ad campaign as a template, move the banner ad campaign to an ad dumpster, and to view summary information of the banner ad campaign. Buttons 410 and 420 enable the user to initiate the banner ad creation process. As noted, the user can create a banner ad using a previously created banner ad as a template or can create a banner ad using a blank template.

A template-based banner ad creation process enables a user to quickly incorporate a variety of user-selectable features into a banner ad. These user-selectable features enable an advertiser to bypass conventional third-party design processes that inevitably slow down the deployment of the banner ad campaign. A variety of user-selectable features can be implemented in a banner-ad-design user interface. The variety of features can be expanded or contracted depending upon the perceived needs of advertisers that seek to obtain a presence on the Internet. An embodiment incorporating a particular set of user-selectable features is described. This set of user-selectable features is not intended to limit the potential applications of the banner-ad-design system of the present invention.

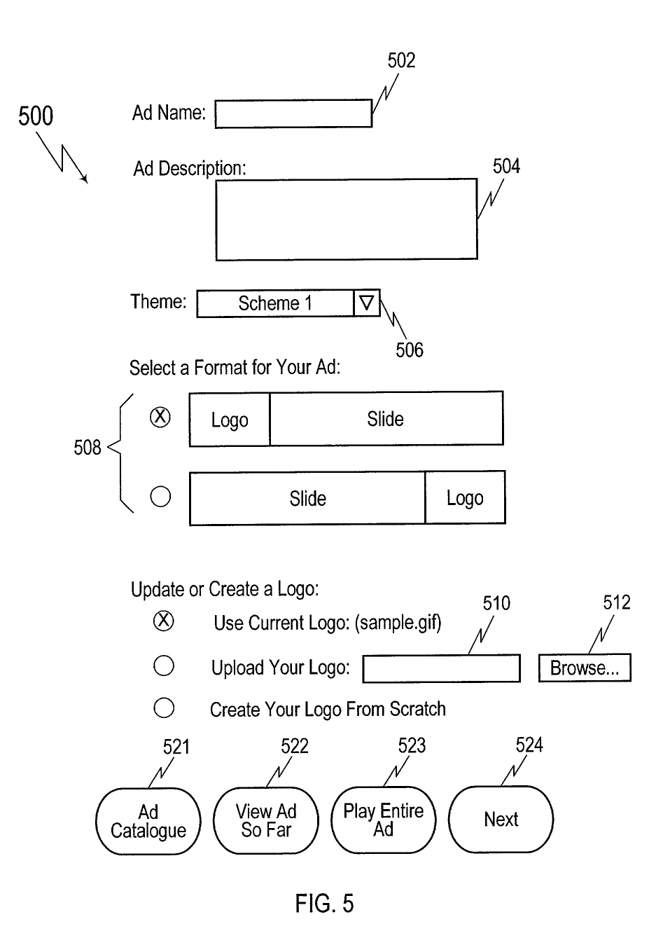

An embodiment of a banner-ad-design user interface is now described with reference to FIGS. 5-11. FIG. 5 illustrates a banner ad overview screen 500. Banner ad overview screen 500 enables a user to specify some of the basic characteristics of the banner ad. After a user enters an Ad Name and an Ad Description in fields 502 and 504, respectively, the user can specify a choice of Theme (e.g., sports, nature, technology, space, underwater, etc.) using scrollable list element 506. Using a theme gives the banner ad consistency and style. The theme selection can be designed to govern a banner ad's background, button style, font, colors, etc.

Next, a user is presented with choices 508 regarding a format for the banner ad. The banner ad format option enables a user to specify a relative layout of a logo display area 222 and a slide display area 224. For example, choosing the first option places the logo on the left-hand side of the banner ad.

The logo to be displayed in logo display area 222 can be uploaded or created. A logo can be uploaded from a file on the user's workstation. To facilitate this process, the user can enter the file name in text field 510 or browse through the file system of the user's workstation using browse button 512. If a logo file was previously uploaded, it will be displayed as the current logo (i.e., sample.gif). Alternatively, the user can create a logo from scratch by specifying a text string along with font, font size, style, and color options in a user interface (not shown).

Having specified some of the basic characteristics of the banner ad, the user is presented with buttons 521-524. Button 521 enables the user to return to ad catalogue listing screen 400, button 522 enables the user to view the banner ad that has been created thus far, button 523 enables the user to play the entire ad, and button 524 enables the user to proceed to the next screen in the banner ad campaign creation process.

In a preferred embodiment, playback by the user of all or part of the banner ad is based upon a pre-compiled applet that supports all of the banner ad features that can be selected through the user interface. As the pre-compiled applet supports all of the features, it may be somewhat large. This pre-compiled applet is in contrast to the applet that is deployed to user workstations 140 that will be viewing the ad. The deployment ad is a fast-loading version that is customized and compiled with the user-selected parameters.

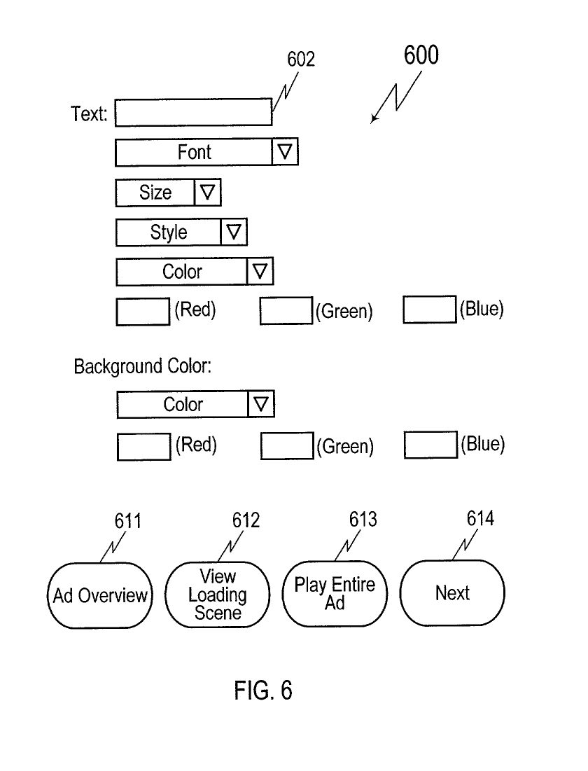

The next screen in the banner ad campaign creation process is loading scene creation screen 600. As illustrated in FIG. 6, screen 600 enables a user to specify a text string in text field 602 that will be displayed in the loading scene. The text string is specified along with font, font size, style, and color options. Screen 600 also enables a user to specify a background color of the loading scene.

Loading scene creation screen 600 also includes buttons 611-614. Button 611 enables the user to return to banner ad overview screen 500, button 612 enables the user to view the loading scene that has been created thus far, button 613 enables the user to play the entire ad, and button 614 enables the user to proceed to the next screen in the banner ad campaign creation process.

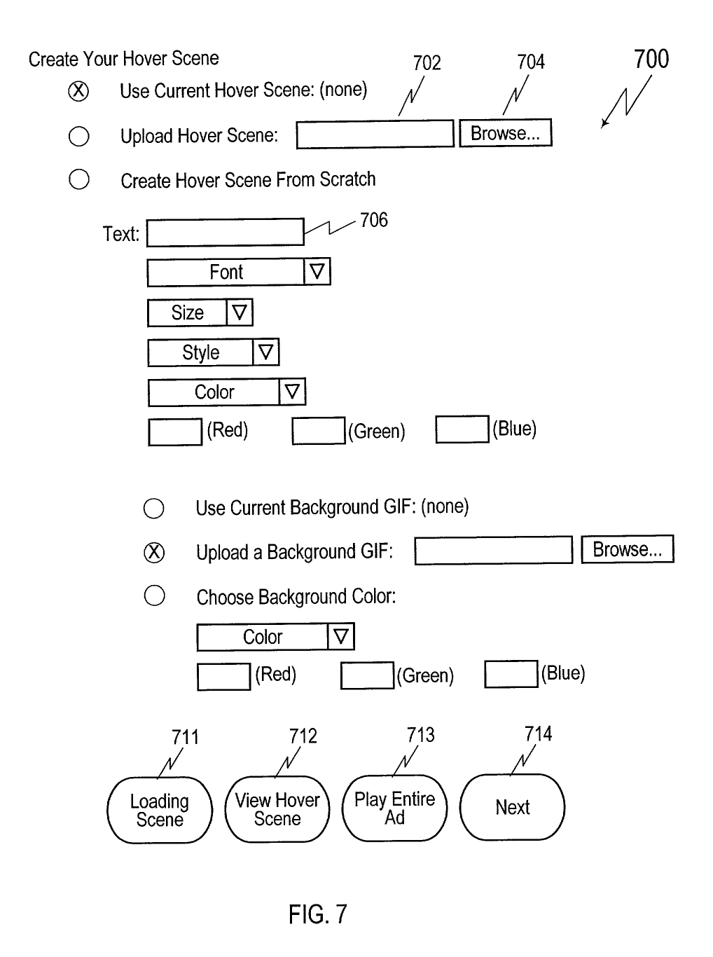

After the loading scene is created, the user can then create an optional hover scene. The hover scene creation screen 700 is illustrated in FIG. 7. The hover scene can be uploaded or created. If the hover scene is to be uploaded, the user can enter the file name in text field 702 or browse through the file system of the user's workstation using browse button 704. If a hover scene was previously uploaded, it will be displayed as the current hover scene. Alternatively, the user can create a logo from scratch by specifying a text string in text field 706 along with font, font size, style, and color options.

Hover scene creation screen 700 also includes buttons 711-714. Button 711 enables the user to return to loading scene creation screen 600, button 712 enables the user to view the hover scene that has been created thus far, button 713 enables the user to play the entire ad, and button 714 enables the user to proceed to the next screen in the banner ad campaign creation process.

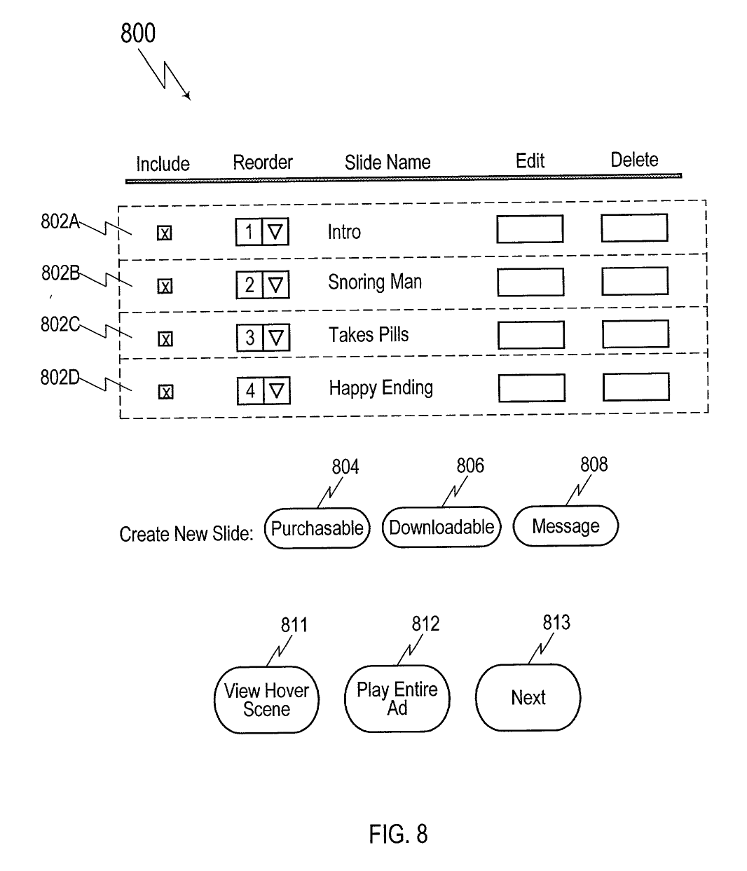

The next screen in the banner ad campaign creation is directed to the creation of a catalogue of slides that will form the attractor loop. The catalogue of slides represents the heart of the advertising content within the banner ad. The catalogue of slides can be created using slide catalogue screen 800 of FIG. 8.

In catalogue screen 800, the user is presented with a listing of one or more slides 802A-802D that have been at least partially defined. For each slide 802A-802D listed, the user can choose to include the slide in the banner ad by checking the include box, change the order in which the slides are displayed by clicking on each reorder box, edit a slide by clicking on the edit button, and delete a slide by clicking on the delete button for that slide. To create a new slide, the user can select either purchasable button 804, downloadable button 806, and message button 808. Purchasable slides advertise an item that is made available for purchase, downloadable slides enable an object to be downloaded or played within the banner ad, and message slides display messages within the banner ad. Purchasable, downloadable, and message slides represent three examples of slides that can be created for the attractor loop. Other types of slides can be created for the attractor loop as would be apparent. To illustrate the process of creating a slide, a purchasable item slide example is examined. The process of creating downloadable or message slides will become apparent from the following description of a forms-based purchasable item slide creation process.

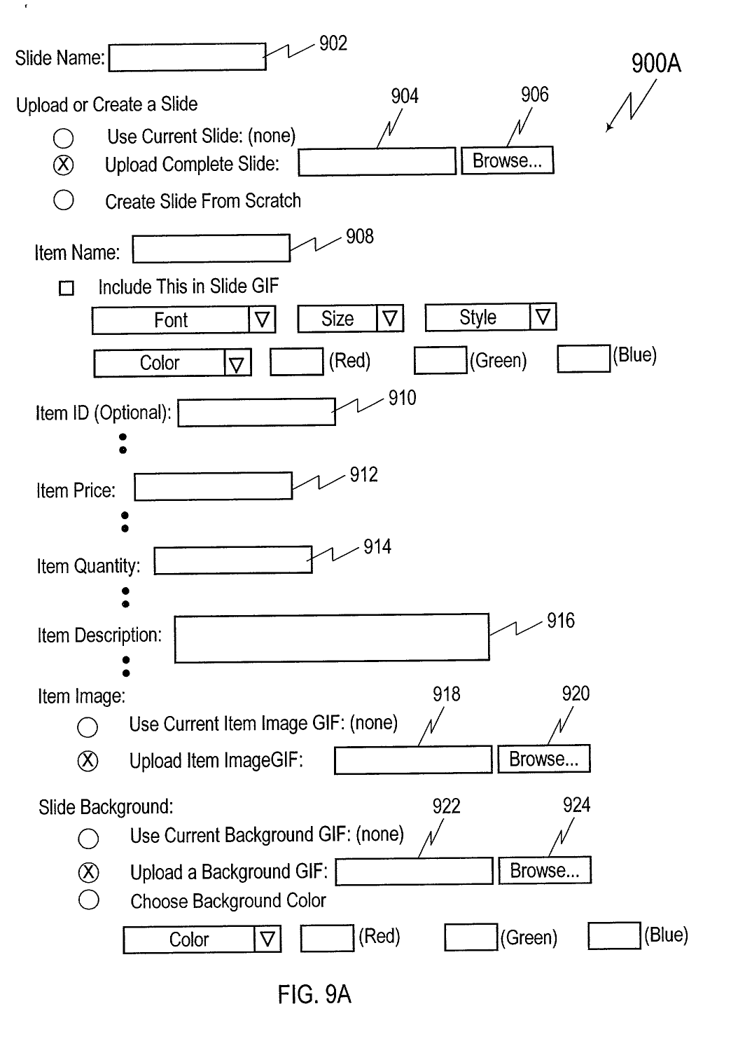

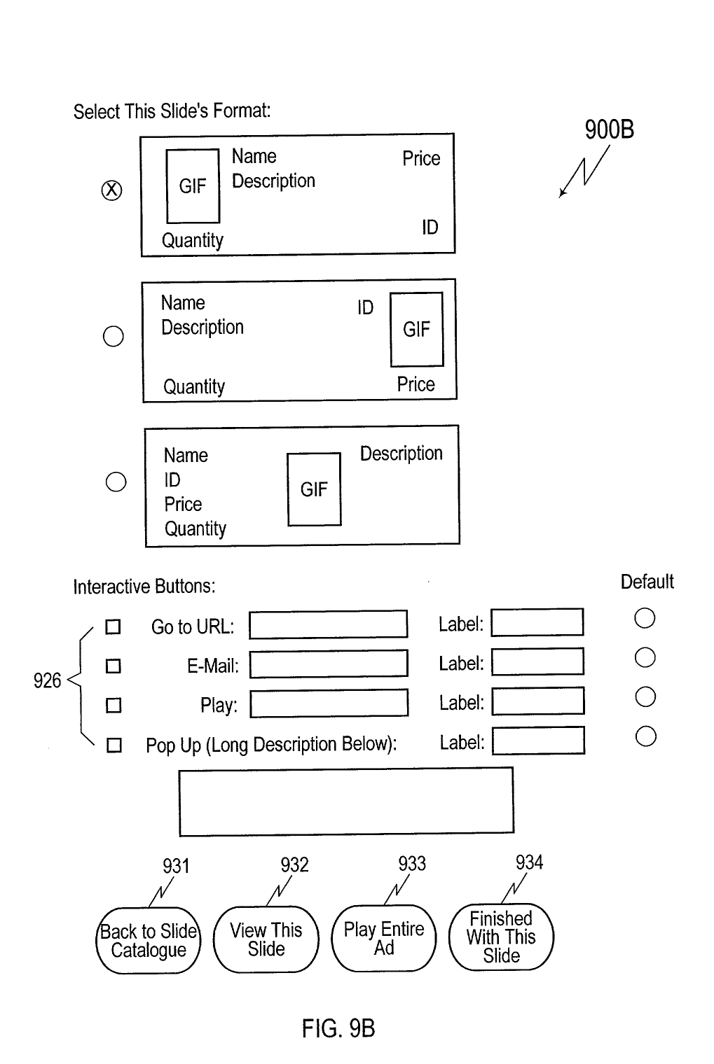

FIGS. 9A and 9B illustrate portions 900A, 900B of a purchasable slide creation screen that enables a user to create a purchasable slide. In purchasable slide creation screen portion 900A, the user first specifies a slide name in text field 902. The purchasable slide can be uploaded or created. If the purchasable slide is to be uploaded, the user can enter the file name in text field 904 or browse through the file system of the user's workstation using browse button 906. If a purchasable slide was previously uploaded, it will be displayed as the current purchasable slide.

Alternatively, the user can create a purchasable slide from scratch by specifying information that applies to the purchasable item. More specifically, the user can specify an item name in text field 908, an item ID in text field 910, an item price in text field 912, an item quantity in text field 914, and an item description in text box 916. For each of these items of information, the user can further specify whether the text information should be included in the purchasable item slide. The user is also instructed to provide an item image. The item image can be uploaded by specifying the file name in text field 918 or browse through the file system of the user's workstation using browse button 920. If an item image was previously uploaded, it will be displayed as the current item image.

As further illustrated in purchasable slide creation screen portion 900A, the user is also prompted to provide a background graphical image (e.g., GIF). The slide background graphics can be uploaded or created. If the purchasable slide background is to be uploaded, the user can enter the file name in text field 922 or browse through the file system of the user's workstation using browse button 924. If a purchasable slide background was previously uploaded, it will be displayed as the current purchasable slide background. Alternatively, the user can specify a background color.

Having specified the descriptive pieces of information for the purchasable item, the user can now specify a layout of the purchasable item slide. The layout format options are selectable from the choices illustrated in purchasable slide creation screen portion 900B. These layouts enable a user to quickly select the relative locations of the item image, item name, item ID, item price, item quantity, and item description.

As described, the forms-based design of scenes and slides enables the user to specify text and graphics as parameters in the scene creation interface. Using a GIF template, the system can automatically generate a GIF using the supplied text strings and GIFs. The GIF template specifies a number of fields. Each field has an extent (in pixels), outside of which, data will not appear. Each field may be a GIF or text. GIF fields take a GIF and can either clip or scale it to the specified extent. Text fields take a text string, and render according to field options such as font style, font size (and whether to autosize or not), foreground color, background color, justification, etc. In creating the final GIF, the system overlays the content of the GIF and text fields onto a background GIF or color. The final GIF can then be displayed as all or part of a scene in the banner ad.

In addition to the description of the item on the purchasable item slide, the user can also include one or more interactive buttons onto the purchasable item slide. These interactive button can be designed to launch a variety of functions such as Go To URL, E-Mail, Play, launch Pop-Up window, etc. Each of these options can be provided in an interactive button menu 926. In a preferred embodiment, one of the buttons is designated as the default button such that a click anywhere within the purchasable item slide will launch the default action.

Pop-Up windows can be used to provide additional information regarding the item displayed in the purchasable item slide. The additional information can include a detailed description along with one or more graphical images. Pop-Up windows can also be defined using a forms-based user interface (not shown). In a preferred embodiment, the Pop-Up windows are HTML based.

After the purchasable item slide has been defined, the user can select one of buttons 931-934. Button 931 enables the user to return to slide catalogue screen 800, button 932 enables the user to view the slide that has been created thus far, button 933 enables the user to play the entire ad, and button 934 enables the user to indicate that the slide is finished and should be saved.

After the user returns to slide catalogue screen 800, the newly created slide will be included as a row in the slide listing table. The user can then reorder the slides in the listing or choose to create additional slides. After the user has completed his interaction with slide catalogue screen 800, the user can select one of buttons 811-813. Button 813 enables the user to return to hover scene creation screen 700, button 812 enables the user to play the entire ad, and button 813 enables the user to proceed with the banner ad campaign creation process.

Each of the slides that have been created are to be displayed in a slide display area (e.g., slide display area 224 of FIG. 2B). The slide display area 224 is complemented by a logo display area that displays, when in manual mode, a set of interactive buttons such as Order/Info, GoTo, Prev, and Next. The Prev and Next buttons can be used to navigate through the slide catalogue. The GoTo button enables the user to click-through to the advertiser's site. The Order/Info button calls up a PopUp window that enables a user to gain additional information as well as order the item displayed in the slide display area.

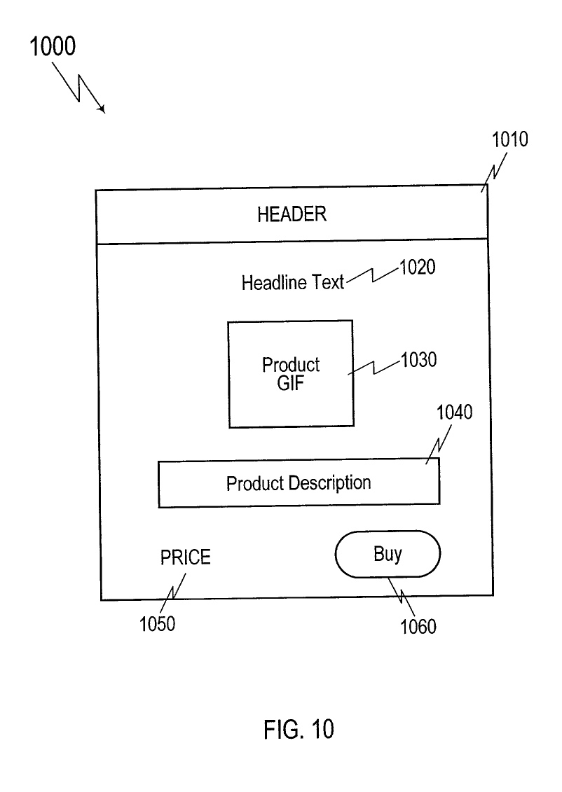

Pop-Up windows are particularly relevant to purchasable item slides. An example of a PopUp order/info page is illustrated in FIG. 10. PopUp order/info page 1000 includes a header section 1010 that may include a company's logo as well as other created text and graphics. PopUp order/info page also includes product information as represented by Headline text field 1020, product GIF 1030, product description field 1040, and price field 1050. Finally, PopUp order/info page includes Buy button 1060 that enables the user to purchase the item. As would be appreciated by one of ordinary skill in the relevant art, the purchasing process can be based upon an electronic shopping cart and other order form windows that enable the system to retrieve demographic and financial information from the user.

PopUp order/info page 1000 can be generated using the same type of forms-based user interface as described above. This forms-based user interface enables the advertiser to design and deploy, in an efficient manner, a banner ad that can offer all elements of electronic commerce. In a preferred embodiment, Pop-Up order/info page 1000 is HTML based.

It should be noted that if a downloadable slide is displayed in the slide display area, then further interactive buttons such as Download and Play can be defined. In that scenario, the Download button calls a download panel for a defined URL and the Play button calls a media player plug-in for a defined URL.

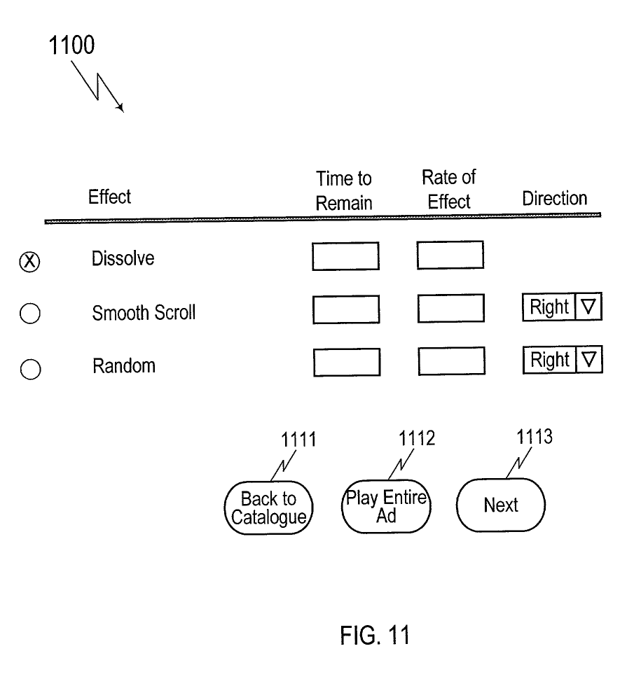

After the catalogue of slides has been defined by the user using catalogue screen 800, the user can then configure the attractor loop. More specifically, the user can specify the effect by which the transition between slides is handled. FIG. 11 illustrates an attractor loop configuration screen 1100. The three options illustrated are dissolve, smooth scroll, and random scroll. For each effect, the user can specify a Time to Remain (in seconds) that a slide will remain visible on the screen and a Rate of Effect that specifies the speed at which the effect occurs. For the smooth scroll and random effect options, the user can also select the direction of the effect's movement.

Attractor loop configuration screen 1100 also includes buttons 1111-1113. Button 1111 enables the user to return to catalogue screen 800, button 1112 enables the user to play the entire ad, and button 1114 enables the user to proceed to the next screen in the banner ad campaign creation process. At this point the user has specified all of the scenes that are to appear in the banner ad. The next step is to identify an advertising channel in which the banner ad will be run. Generally, an advertising channel is a collection of websites that have a common theme or topic (e.g., sports or pets). To enhance the effectiveness of the advertising campaign, advertisers are able to specify one or more channels in which the advertisement should be run. The individual advertising channels can be predefined or can be created by the advertiser.

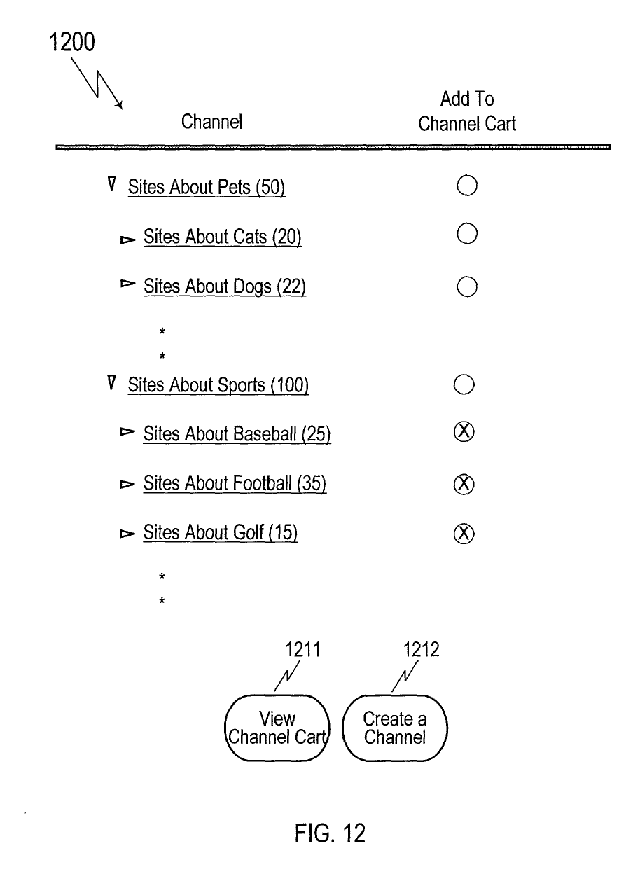

FIG. 12 illustrates an embodiment of an advertising channel selection screen 1200 that enables an advertiser to select one or more predefined channels for use in an advertising campaign. The predefined channels can be hierarchically organized such that an advertiser can select the breadth of representation within a particular theme or topic. Consider the example hierarchy illustrated in FIG. 12. The hierarchy of channels includes the broader channel categories of pets and sports. Each of the broader channel categories includes subcategories that further break down the theme or topic. For example, the channel category of sports includes further subchannels directed to baseball, football, and golf. It should further be noted that the broad categories of pets and sports can be part of even broader channel categories such as animals and entertainment, respectively.

The advertising channel selection screen 1200 enables an advertiser to explore the list of channels by expanding and contracting the levels in the hierarchy. Each particular channel can be further examined by clicking on the hyperlinked channel list elements. A selection by an advertiser of a hyperlinked channel list element will reveal the list of individual websites that are identified in quantity by the hierarchical list.

After the advertiser has investigated the list of channels, the advertiser can select individual predefined channels for inclusion in his advertising campaign. As noted above, the advertiser can also create a customized channel. This creation process is enabled through the selection of button 1212. Based on a user interface screen (not shown), the advertiser can modify a predefined channel or can customize a channel by specifying the individual websites. After the channel has been created, the user is returned to channel selection screen 1200. The selection process can then be completed through the designation of the list of channels that are to be included in the channel cart, and the selection of button 1211.

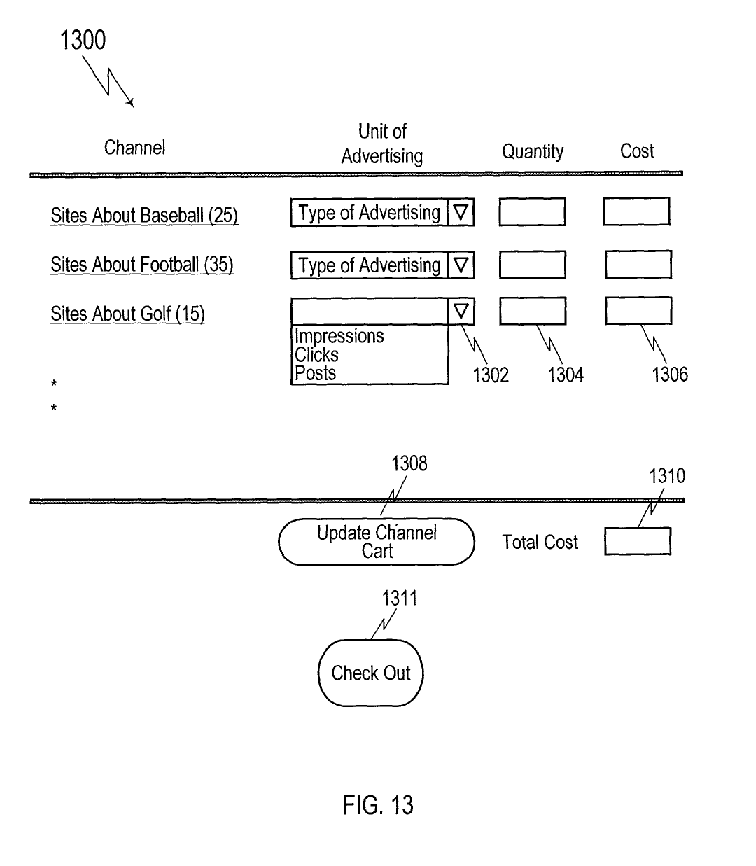

The channel cart view is a mechanism for specifying the detailed parameters of the advertising campaign. The channel cart operates in a manner similar to a conventional electronic shopping cart. An embodiment of a channel cart view screen 1300 is illustrated in FIG. 13. In the channel cart view screen 1300, the list of selected channels is displayed in a table. For each channel, the advertiser can specify the units of advertising that he wishes to purchase. In channel cart view screen 1300, the advertiser is given a choice of purchasing advertising on a per-impression, per-click, or per-post basis. As would be appreciated by one of ordinary skill in the relevant art, various other units of advertising can be purchased.

To illustrate this process, consider the channel “Sites About Golf.” For this particular channel, the user first specifies the unit of advertising using scrollable list 1302. After the unit of advertising has been selected, the advertiser can then designate a quantity in field 1304. For example, if “Impressions” has been selected as the unit of advertising, the advertiser can specify a quantity such as 5,000, while if “Clicks” has been selected as the unit of advertising, the advertiser can specify a quantity such as 100. After a quantity has been specified for the channel, a cost will be determined and displayed in field 1306. Following this process for each of the selected channels, the advertiser can specify the operating parameters of the entire advertising campaign. If the total cost appearing in field 1310 is agreeable to the advertiser, the advertiser can then proceed to the check out screen using check out button 1311. As would be appreciated by one of ordinary skill in the relevant art, the check out process can use standard electronic commerce forms and payment systems.

It should be noted that the embodiment represented by channel cart view screen 1300 represents only a single level of channel granularity with respect to the purchasing process. In other embodiments, the determination of the amount of advertising can be specified for an arbitrary level of the channel hierarchy. For example, if a general channel about sports has been selected, the advertiser may specify the individual quantities of advertisement for each of the subchannels rather than specifying the quantity of advertisement for the sports channel as a whole. Moreover, the advertiser may wish to specify the quantities of advertisement for individual websites that are included within a particular channel. This feature enables an advertiser to target the advertising in a specifically-defined manner.

After an advertising campaign has been specified and paid for, the advertiser will receive, from the ad serving entity, a list of unique URLs (one list for each channel). These URLs are provided to the various affiliate websites included within the channel list. The individual affiliate sites can then use the URL to go the ad serving entity's site for registration. Upon completion of the registration process, the affiliate web site will then receive the tag (e.g., applet tag) to be inserted within the web page data to be transmitted to requesting user workstations 140.

Having specified the design of the banner ad and one or more advertising channels in which the designed banner ad is to be run, the banner ad can be submitted for deployment. As a final step of the design process, the banner ad content can be checked to ensure that the content is not offensive in nature. After this manual or automated content review process, the banner ad parameters selected by the user can be used to prepare a deliverable banner ad.

In a preferred embodiment, the deliverable banner ad is customized and compiled as a Java applet using the user-selected banner ad parameters. It should be noted that the deliverable banner ad can be generated in any format (e.g., Macromedia Flash ad) that is readable by a web browser. The embodiment of a banner ad as a Java applet is advantageous because when the banner ad Java applet gets loaded on the web page, it can periodically, or at specific times (e.g., mouse events), send information from the ad or events occurring in the banner ad back to the server via a virtual link. The information can then be stored in a database (not shown). This information can be used to track general and specific user interaction with the banner ad, thereby providing a means for assessing banner ad performance on the network.

It should be noted that not all browser systems and associated networks are Java enabled. Accordingly, the user-selected banner ad parameters are also used to create both a GIF version, a Macromedia Flash ad, and a JavaScript/Dynamic HTML version of the banner ad. In this manner, the ad delivery system of the present invention can serve banner ads that can be viewed by any user workstation 140.

It is a feature of the present invention that the automated design and configuration of a banner ad leads to a significantly reduced time for actual deployment of the banner ad. Where third parties participate in the design and re-design process, banner ads may not be able to capture a quickly-moving market opportunity.

After the banner ad campaign is deployed, the advertiser can monitor the performance of the banner ad by reviewing the statistics of the advertising campaign. An example of a basic set of statistics for an advertising campaign is illustrated in Table 1. The statistics of Table 1 include the number of Total Impressions, Java Impressions, GIF Impressions, Total Clicks, Java Clicks, GIF Clicks, Total Posts, Java Posts, and GIF Posts. In this example, it is assumed that two forms of the banner ad are being served, i.e., Java applet and GIF ads. For each banner ad type, the number of impressions, click-throughs, and posts are charted.

TABLE 1

| | Total | Java | GIF | Total | Java | GIF | Total | Java | GIF |
|---|---|---|---|---|---|---|---|---|---|
| Date | Impressions | Impressions | Impressions | Clicks | Clicks | Clicks | Posts | Posts | Posts |
| 2/1/99 | 40432 | 29515 | 10917 | 1706 | 1564 | 142 | 264 | 250 | 14 |
| 2/2/99 | 34812 | 26716 | 8096 | 1521 | 1416 | 105 | 238 | 227 | 11 |
| 2/3/99 | 40470 | 29929 | 10541 | 1723 | 1586 | 137 | 168 | 154 | 14 |
| 2/4/99 | 42421 | 31480 | 10941 | 1811 | 1668 | 142 | 281 | 267 | 14 |
| 2/5/99 | 40122 | 29574 | 10448 | 1705 | 1567 | 137 | 265 | 251 | 14 |
| 2/6/99 | 36547 | 27582 | 8965 | 1578 | 1462 | 117 | 246 | 234 | 12 |
| 2/7/99 | 37528 | 29251 | 8277 | 1658 | 1550 | 108 | 259 | 248 | 11 |
| Total | 1,064,053 | 813,621 | 250,432 | 46,378 | 43,122 | 3,256 | 7,230 | 6,900 | 330 |

After reviewing the set of statistics such as those listed in Table 1, the advertiser can then assess the effectiveness of the advertising campaign. If the response has thus far been lackluster, the advertiser can decide whether to halt and/or redesign the advertising campaign. If this course of action is desired, the advertiser can review and edit the content of the banner ad campaign from ad catalogue listing screen 400. From ad catalogue listing screen 400, the advertiser can redesign the content of the ad or adjust the channels in which the banner ad is being displayed. This redesign process can be efficiently performed and ensures that the banner ad can be redeployed without experiencing significant downtime.

It should be noted that the redesign process can also be initiated by the advertiser based upon detailed statistics beyond the basic set of statistics illustrated in Table 1. Additional statistics such as the time of the mouse in the banner ad, types of interaction with the banner ad, etc., can be generated by the Java applet banner ad. These detailed statistics can give the advertiser insight into portions of the banner ad to which users are not responding. These non-responsive areas are prime candidates for a redesign.

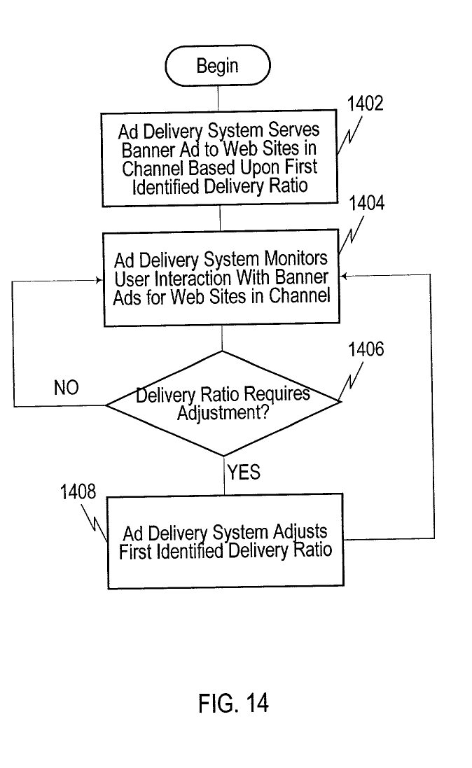

As thus described, adjustments to a banner ad campaign can be initiated by the advertiser. It is a further feature of the present invention that adjustments to a banner ad campaign can also be initiated by the banner ad delivery system itself. More particularly, the banner ad delivery system can monitor the banner ad campaign and modify the delivery schedule of the banner ad to effect a form of yield management. The yield management process is illustrated by the flowchart of FIG. 14.

To illustrate the yield management process, consider a scenario where an advertiser has designed an ad and selected an advertising channel of four web sites A-D in which to display the ad. Using the channel cart view screen 1300, assume that the advertiser has purchased a hundred clicks/day for the selected advertising channel for a period of X days.

As a first step in the yield management process, the ad delivery system first determines, at step 1402, a delivery ratio for web sites A-D in the selected advertising channel. This delivery ratio generically represents an implicit or explicit control over the relative number of target impressions that the banner ad will receive for each of web sites A-D in the selected advertising channel. As can be appreciated, this delivery ratio may not be uniform over the web sites in the selected advertising channel. This non-uniformity in delivery ratio can result from the non-equal values that can be placed on the various advertising forums (i.e., web site, web page, web page location, etc.) in which the banner ad will appear. Indeed, the non-equal values of the advertising forums will typically be used in determining a weighted-cost of advertising in a particular channel/subchannel.

In the present example where the advertiser has purchased one hundred clicks to be generated from the four web sites A-D in the selected channel, assume that the ad delivery system has set up an impressions target in accordance with Table 2.

TABLE 2

| Advertising Channel X | # of Impressions/Day |
|---|---|
| Web Site A | 600 |
| Web Site B | 400 |
| Web Site C | 300 |
| Web Site D | 200 |
| Total | 1500 |

As illustrated in Table 2, web site A is scheduled to receive 600 Impressions/Day, web site B is scheduled to receive 400 Impressions/Day, web site C is scheduled to receive 300 Impressions/Day, and web site D is scheduled to receive 200 Impressions/Day. After this delivery schedule has been produced in accordance with the initially identified delivery ratio, the ad delivery system can then proceed to serve the banner ad to the four web sites A-D in the selected channel.

These banner ad impressions eventually produce the desired advertising effect of enticing the viewer to interact with the banner ad. At step 1404, the ad delivery system is operative to monitor the user interaction with the banner ad. Based on these statistics, the ad delivery system can then determine, at step 1406, whether the previously determined delivery ratio should be adjusted. This scenario can occur when the impressions for a given web site are producing a disproportionately large or small response rate as compared to an expected response rate. In one embodiment, this determination process is based on a comparison of the ratio of clicks to the number of impressions across the web sites in the channel. Clearly, other mechanisms for determining the relative proportionality of response rates can be used without departing from the scope of the present invention.

Based on the examination of response rates by the individual web sites A-D in the channel, the ad delivery system can then determine whether the delivery ratio should be adjusted. If the response rates are not unexpected, then the original delivery ratio is left intact and the ad delivery system continues to monitor user response rates.

If, for example, web site B is generating a disproportionately small response rate while web site D is generating a disproportionately large response rate, then an adjustment of the delivery ratio may be required. If a delivery ratio adjustment is required, then the yield management process proceeds to step 1408. At step 1408, the ad delivery system determines the delivery ratio adjustments that are required. In the above example, the target number of impressions on web site B may simply be reduced in favor of an increased number of impressions on web site D. After the delivery ratio is adjusted, the ad delivery system continues to monitor user response rates.

It should be noted that this adjustment process may not be based on a zero-sum gain amongst the total target of impressions for the web sites in the selected channel. This could result due to ad traffic considerations that relate to agreements between the affiliates and the ad serving entity. Notwithstanding this consideration, the ad delivery system can modify the ratio to a degree such that the total click/impression ratio for the channel is improved. Improvement of the total click/impression ratio maximizes the effectiveness of limited resources and thereby enhances the value of the ad serving entity's operation.

It should further be noted that the adjustment of the delivery ratio can be based upon various levels of granularity. In the example discussed above, the delivery ratio adjustment was initially determined based upon delivery to the web sites as a whole. Further detailed statistics can also be used to adjust the delivery ratios to the individual web sites. For example, the ad delivery system may determine based upon received statistics that a particular banner ad generates a greater response rate when (1) placed in a particular page on a web site, (2) placed on a particular portion of a web page, (3) placed on a particular web site at a particular period of time during a day, etc. Any type of detailed performance statistic can be used to adjust the delivery ratio for the web sites in the channel. To effect these modifications, the delivery ratios themselves may require a specification at a finer granularity.

The yield management process as thus described enables an ad delivery system to maximize its ad serving efforts. This maximization process can be cumulatively applied to conventional targeted ad serving efforts that seek to define the area of proper ad placement. These conventional techniques merely define a set of pre-delivery rules that govern the ad serving process. These pre-delivery rules are simply estimates of where the ad is likely to receive the best user response. The yield management process of the present invention, on the other hand, further refines the pre-delivery rules by using real-time empirical information to determine where the banner ad will be most effectively displayed.

The efficiency of the ad delivery system is an important component in producing paid-for results at a minimal cost. In effect, the efficiency of the ad delivery system increases the ad delivery system's total $/impression ratio. This $/impression ratio is particularly important when the ad delivery system is at or near its total throughput capacity.

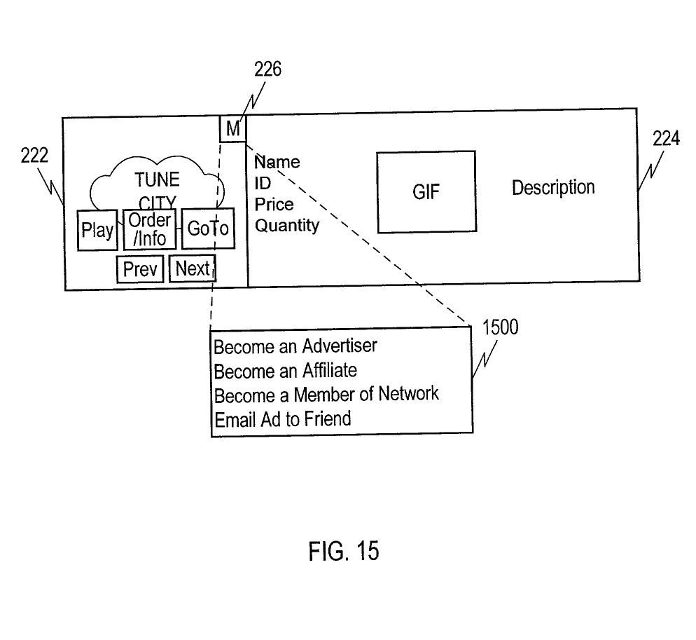

It is a further feature of the present invention that a viral marketing mechanism can be used to rapidly expand the reach and utility of the ad serving network. This viral marketing campaign can be effected by including a small, unobtrusive branded viral icon on each banner ad served. An example of this unobtrusive icon is illustrated in the banner ad of FIG. 15. As illustrated, the banner ad includes within logo display area 222, a mysterious icon 226 in the logo display area. In one embodiment, mysterious icon 226 is animated as a seductive and mysterious portion of the logo display area 222 that invites the user to move his mouse over mysterious icon 226.

If the user's mouse is moved over mysterious icon 226, a popup menu 1500 appears that gives the user the options of becoming an advertiser, becoming an affiliate, becoming a member of the ad serving network, or emailing the banner ad to a friend. Through this viral marketing campaign, the ad network can be expanded across multiple dimensions. More specifically, the ad serving network is expanded across (1) the set of advertisers that are placing banner ads on the network, and (2) the set of affiliates and ad network members that are willing to display banner ads on their web site. The final option of emailing the banner ad to a friend further enables the prospective viral marketing to be passed on to users that may not have come in contact with the banner ads served by that particular ad serving entity.

This multi-dimensional viral marketing campaign represents a powerful improvement over conventional one-dimensional viral marketing campaigns. For example, consider the one-dimensional viral marketing campaign of Microsoft's Hotmail™ product. In this viral marketing campaign, each email composed by a Hotmail™ subscriber includes the following message “Get Your Private, Free Email at http://www.hotmail.com.” This email trailer includes a hyperlink that enables a recipient of the email message to go to the Hotmail™ web site to set up their own free email account.

While the Hotmail™ viral marketing campaign has proved successful, it can only expand the list of subscribers to the system. This one-dimensional viral campaign is distinguishable from the multi-dimensional viral campaign of the present invention. In the viral marketing campaign of the present invention, not only are subscribers (i.e., advertisers) being added to the system, but the network itself (i.e., affiliates and network members) is also being expanded. Accordingly, through the viral campaign of the present invention, both the use and capacity of the ad delivery network are expanded. This multi-dimensional viral marketing campaign is therefore effective in ramping up the use and capacity of an ad serving network in a short period of time.

As described in the embodiment above, the user interfaces illustrated in FIGS. 4-8, 9A, 9B, and 11-13 provided a user with fine-grained controls for creating and deploying an online ad campaign. In addition to specifying advertising content, the user could also use the fine-grained controls to specify detailed display and format characteristics of the online ad. For example, the user could define the font, font style, point size, and color of elements of advertising content within each scene or slide. In effect, the user would provide a top-to-bottom design of the entire online ad.

Once the user completed the initial design of the online ad, the user could play the online ad to determine whether it met the user's original advertising intent. Modification to the online ad was effected through an editing process that reworked the original display and format characteristics of the online ad.

In a second embodiment of the present invention, the ad creation process has been simplified to increase the effectiveness of the system in creating a suitable online ad. In the first embodiment, users were provided with an interface that enabled the user to specify detailed online ad characteristics. For example, users were called upon to specify font, size, style, and color characteristics of individual textual elements. Additionally, users were called upon to specify an ordering of slides and types of transitions between those slides. While these interfaces provided significant cost and time-to-market advantages relative to the use of online ad designers, the interfaces of the first embodiment did not maximize its usability as a turnkey solution for generating online advertising.

In the second embodiment, the user directs the creation of the online ad without having to specify the detailed characteristics of the online ad. In this process, users are not sequentially prompted with detailed ad specification options. Rather, users are first called upon to specify a generalized ad directive that embodies the user's general advertising intent. By divining the user's general advertising intent, the ad creation process of the present invention can automatically create a set of candidate ads that are believed to express the intent and desired focus of the user.

It is therefore a feature of the present invention that the usability of the online ad generation process is improved. In the second embodiment, users are not called upon to provide the bulk of the online ad design. Rather, the ad generation system creates the online ads under the general direction of the user. This automatic online ad creation process enhances the user's ability to realize an effective advertising campaign without delay. Significantly, the transfer of the primary responsibility for online ad design away from the user ensures that seamless, professional-grade online ads can be produced.

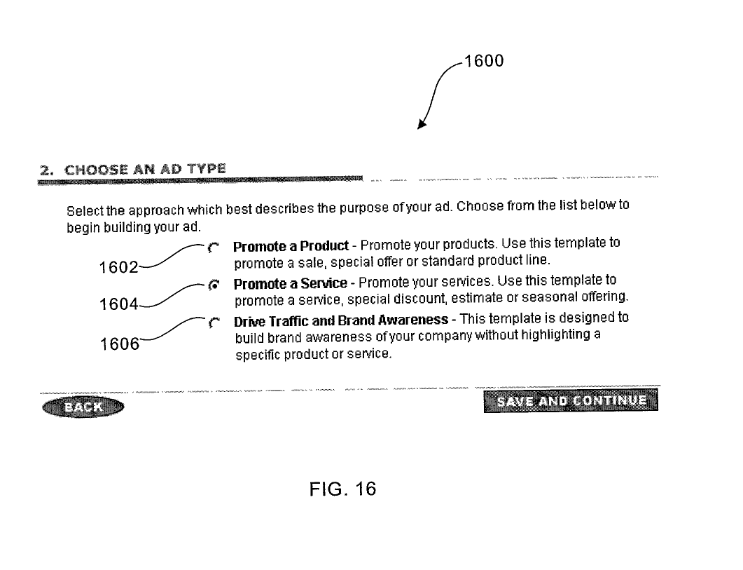

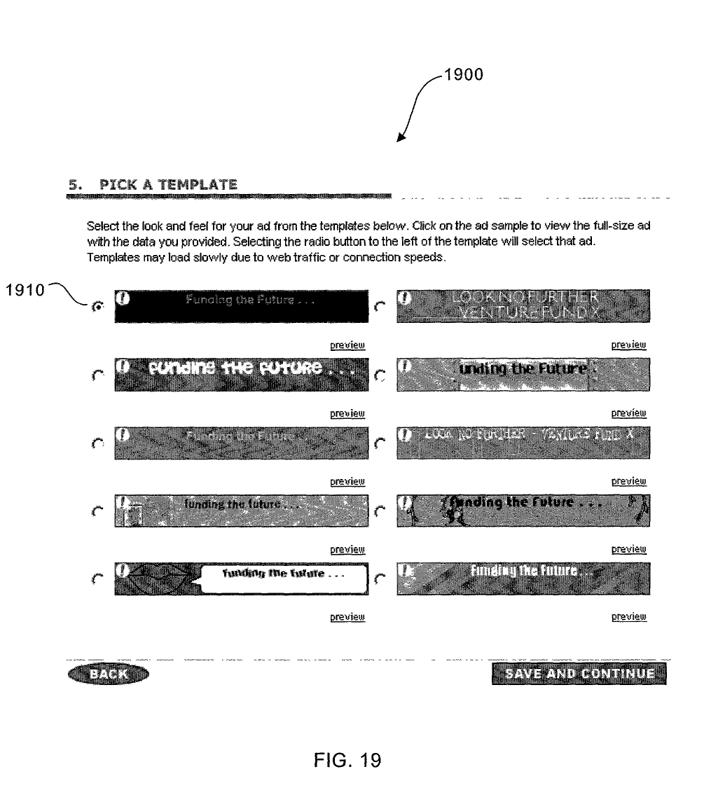

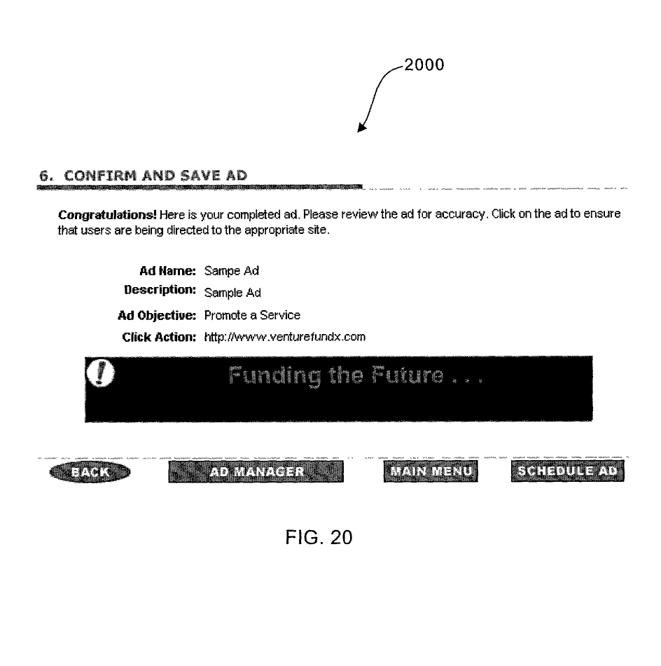

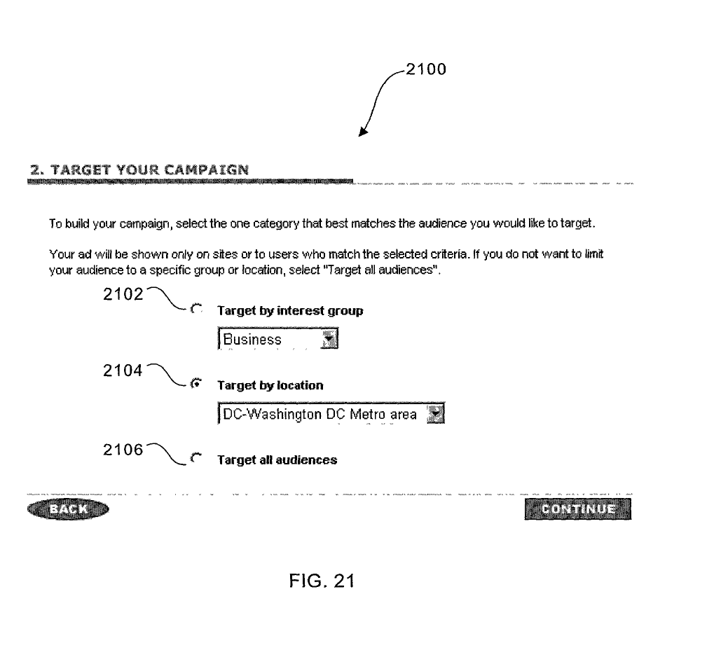

As noted, the user need not play an active role in the actual detailed design of the ads. Rather, the user's role is focused upon the content and objective of the ad. In a sense, the user can be envisioned as an ad director rather than an ad designer. Illustration of this ad creation process is now provided with reference to FIGS. 16, 17A-17C, and 18-21, which illustrate a sequence of user-interface screens.

FIG. 16 illustrates an embodiment of an ad objective screen 1600. Ad objective screen 1600 represents the beginning of the ad creation process. Here, the user is called upon to define the general objective of the online ad. In the illustrated embodiment, the user can indicate a desired ad purpose through the selection from a set of ad objectives using radio buttons 1602, 1604, 1606. Radio buttons 1602, 1604, 1606 are respectively associated with the following ad types: “Promote a Product,” “Promote a Service,” and “Drive Traffic and Brand Awareness.” As would be appreciated, further ad objectives can also be defined beyond the examples provided in ad objective screen 1600. Additionally, it should be noted that the indication of a desired ad purpose can be accomplished in a variety of ways other than the use of radio buttons.

The “Promote a Product” ad type represents a typical sales oriented ad campaign. The general objective for this ad type would be to display details (e.g., product photo or price information) of a particular product that is being offered for sale. The focus of this type of ad would be on the product itself. The “Promote a Service” ad type is similar to the “Promote a Product” ad type. Instead of focusing on an offered product, the ad is focused on an offered service.

Unlike the previous ad types, the “Drive Traffic and Brand Awareness” ad type is focused on a company, rather than a product or service. This type of advertising is part of a general information dissemination campaign and is not focused on the consummation of an immediate sale.

As can be appreciated, the different focus of each of these ad types suggests that a different online ad design should be used. Almost by definition, all advertising campaigns are not created equal. Accordingly, variations in theme would dictate variations in the design of the online ad.

It is a feature of the present invention that the specification of an ad objective by the user can be used to drive the ad creation process. In one embodiment, the specification of an ad objective (or type) can be used to identify one or more specific forms of type-dependent ad data that should be retrieved from the user. For example, the selection of a “Promote a Product” ad type would suggest that a product sales price should be retrieved, while the selection of a “Drive Traffic and Brand Awareness” ad type would not require a sales price. The request and retrieval of type-dependent ad data ensures that the online ad design would be tailored to the original ad objective.

It should be noted, however, that in one embodiment, a single superset of ad data can be requested from the user regardless of the selected ad objective. In this scenario, the ad generation system would select the appropriate fields from the superset of ad data that should be emphasized in the online ad for the selected ad objective. In general, the targeted nature of the ad design process is a product of the principle that a single ad specification and creation process would not yield optimal results when applied across diverse ad objectives.

Selection from diverse ad objectives is enabled through radio buttons 1602, 1604, 1606 in ad objective screen 1600. These radio buttons are associated with predefined ad objectives. It should be noted that the ad objectives illustrated in ad objective screen 1600 are not intended to be exhaustive. Indeed, there is no limit to the number of additional ad objective categories or sub-categories that can be defined and made available to the user. Their subsequent effect on the ad creation process will become apparent from the following description.

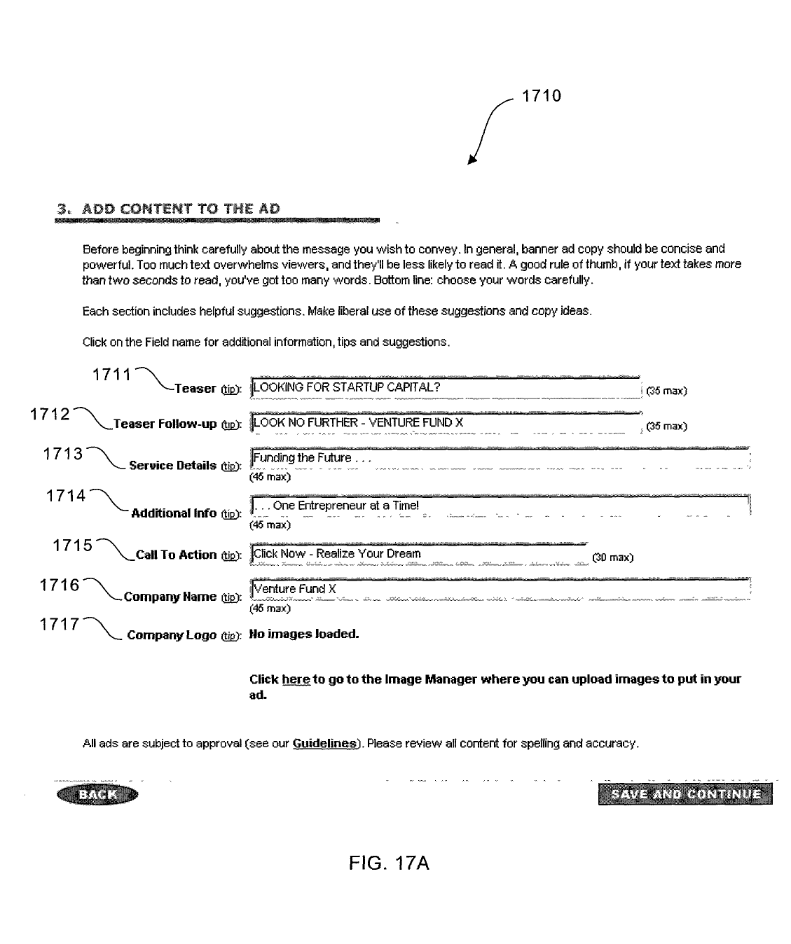

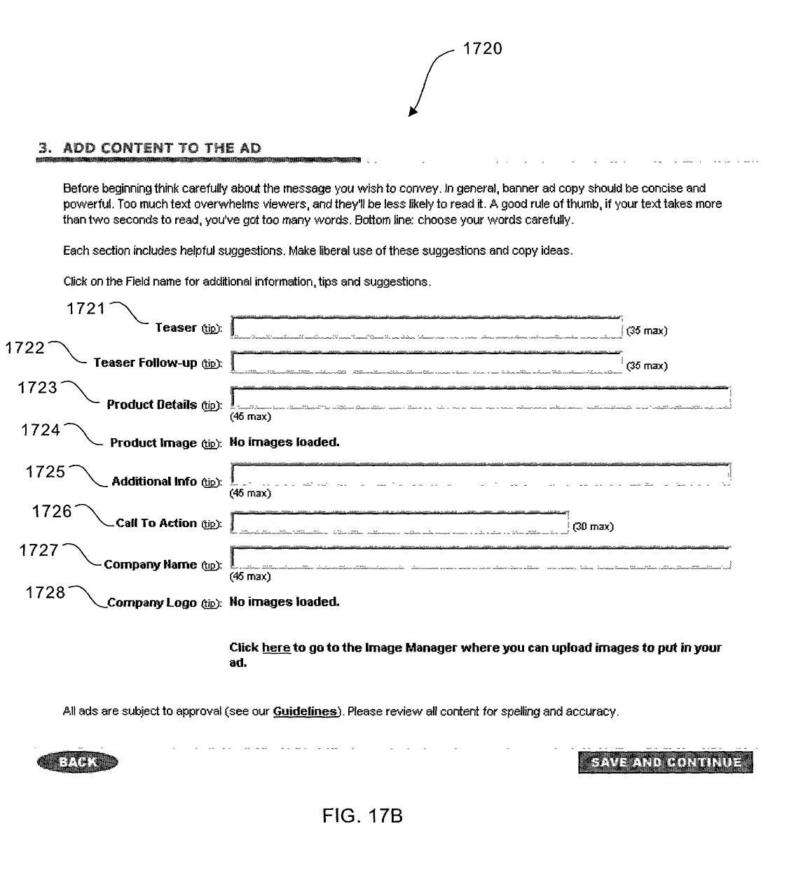

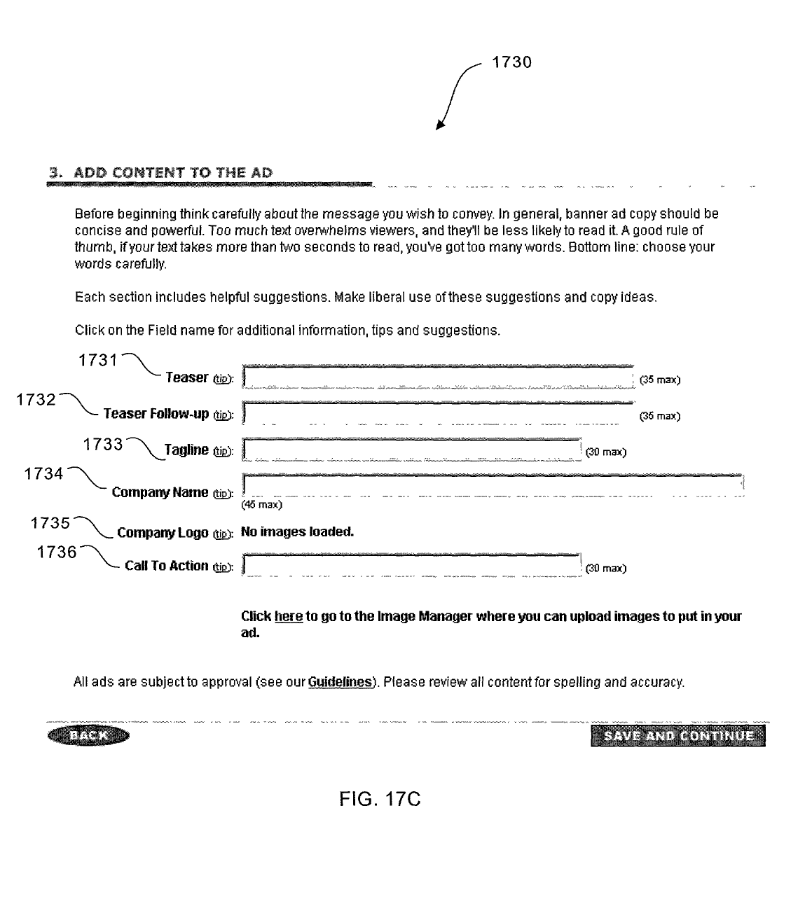

Upon selection of an ad objective, the user is presented with an ad data entry screen. FIG. 17A illustrates ad data entry screen 1710, which is presented to the user upon selection of ad objective “Promote a Service” using radio button 1604. Ad data entry screen 1710 includes text entry fields 1711-1716. Text entry fields 1711-1716 enable a user to specify textual content for the service offering that is the subject of the online ad. More specifically, the user can provide textual data for the following categories: “teaser,” “teaser follow-up,” “service details,” “additional info,” “call to action,” and “company name.” Control 1717 is used to select image data to be used for a “company logo.” The provision of the requested text and image data enables the creation of an online ad that is targeted to the selected ad objective. In particular, each of these pieces of requested information is known to have a particular relevance to the selected ad objective and can therefore be used accordingly. For example, consider the selection of an ad type in the category (Sales) and the sub-category (Price Sensitive). If a price figure is included in the ad data entry screen for that ad type, then the role of the price would be known to play a critical role in generating user interest. This knowledge would dictate that the price figure should be displayed often and prominently throughout the generated online ad. As would be appreciated, this strategy would not be applied in a Non-Price Sensitive sub-category where the brand name may play a greater role in generating user interest.

FIGS. 17B and 17C illustrate alternative ad data entry screens 1720 and 1730, respectively. Ad data entry screen 1720 is produced when the user selects the “Promote a Product” ad type, while ad data entry screen 1730 is produced when the user selects the “Drive Traffic and Brand Awareness” ad type.

As noted, the various ad objectives may require the specification of different types of ad data. This difference is illustrated in the comparison of ad data entry screens 1710 and 1720. Ad data entry screens 1710 and 1720 are associated with “Promote a Product” and Promote a Service” ad types, respectively. These two ad objectives are sales oriented and therefore similar in many respects. However, one ad objective is focused on a product while the other is focused on a service. For this reason, ad data entry screen 1720 includes an additional control 1724 that enables the user to select image data to be used in describing the product being advertised.

Further differences are illustrated in the comparison of ad data entry screens 1710 and 1730. Here, ad data entry screen 1710 includes text entry fields 1713, 1714 for “service details” and “additional info.” Ad data entry screen 1730, on the other hand, includes text entry field 1733 for a “tagline.” While text entry fields 1713 and 1714 are used to describe details of a service offering, “tagline” entry field 1733 is used to provide a short, easily remembered phrase that the user wants associated with a product or service. As can be appreciated, the association of these textual elements to the overall ad objective can greatly influence the placement and use of the textual data in an online ad.

In general, the similarity between two ad objectives will dictate the amount of similarity between the items of ad data that are requested from the user. In the above examples, the ad objectives are satisfied largely through the provision of textual data along with one or more pieces of image data. In other examples, a particular ad objective could rely almost exclusively on image data, or could rely on dynamically changing data that exists at another website. In general, the various ad objectives could dictate not only the types of ad data that are required but also the use of the ad data within the ad design.

For example, a particular ad objective directed to the display of a live auction in an online ad may dictate that the user should specify a URL in the ad data entry screen. This URL would identify a location where dynamic data can be retrieved. In one example, this dynamic data can exist in HTML or extensible markup language (XML) format that is to be parsed to identify the auction data. The retrieved auction data can then be included within the online ad that is generated.

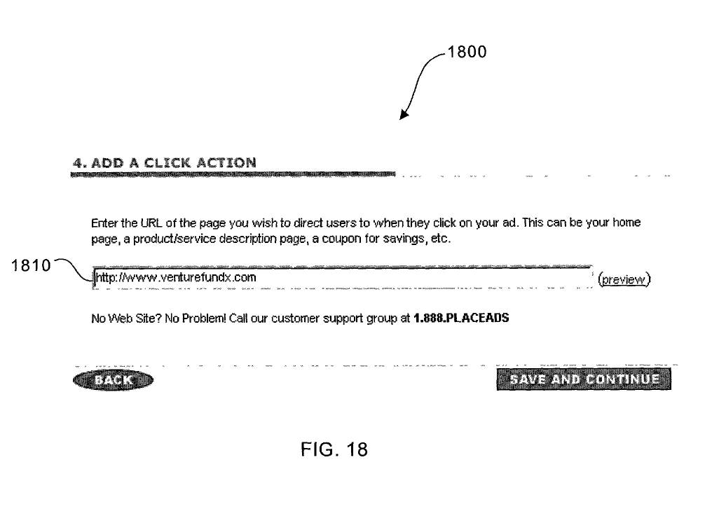

After entry of the ad data using an ad data entry screen 1710, 1720, 1730, the user is then presented with click action screen 1800, illustrated in FIG. 18. Click action screen 1800 enables a user to identify the specific course of action that occurs when a user clicks on the online ad. The most common online ad behavior is the click-through. To support this scenario, the user would provide the relevant URL in text entry field 1810. This URL would enable the user to visit the website of the advertiser's choice. In one embodiment, a new web-browser window is opened with the specified URL along with an advertisement for the ad network operator. In this embodiment, the original website screen that included the displayed ad would not be disturbed.

As can be appreciated, additional types of “click action” can be defined. In one example, sales-oriented ad objectives would include a click action screen that enabled the advertiser to specify an online coupon for a discount on the advertised service or offering. Upon a click onto the online ad, the online coupon would be displayed in a pop-up window that would enable the user to print the online coupon. In one embodiment, the click action screen would prompt the user for the content of the coupon (e.g., value of the coupon). This content data would be used to generate an online coupon that was consistent in style and presentation with the generated online ad.

In another example, a click action screen would enable the user to create a text entry form. This text entry form would prompt users to enter personal information (e.g., name, address, etc.) that is to be provided to the advertiser. In one embodiment, the text entry form would be automatically generated through the identification of conventional personal information entry fields. As can be appreciated, this sales lead information can be delivered to the advertiser individually upon receipt or as a group after having been collected during a particular period of time.

After the appropriate click action has been specified, the user is then presented with ad preview screen 1900. Ad preview screen 1900 displays a plurality of ads that have been generated in accordance with the ad objective and the provided ad data. Each of the displayed ads is based on a template that is associated with the selected ad objective. The various ad templates are populated with the ad data that is provided by the user.

In one embodiment, the selection of the particular ad templates would be dependent upon the input provided by the user. In other words, particular ad templates can be selected based upon consideration of the identified ad objective and the ad data that has been provided by the user. For example, consider again the selection of an ad type in the category (Sales) and the sub-category (Price Sensitive), wherein the price figure is provided by the user in the ad data entry screen. In this situation, the ad template that is designed to display the price figure often and prominently would be selected over an ad template that was designed to prominently display the brand name.

In another embodiment, programmatic logic within an ad template could be used to produce variations in the generated online ad. For example, the programmatic logic could be used to determine what type of ad data to use and how to emphasize that ad data within the online ad. This would enable the particular ad template to generate ads that were targeted to a known ad objective. In general, these decisions could be based upon consideration of the identified ad objective and the ad data that has been provided by the user. As would be appreciated, these two embodiments could also be used in combination to provide a responsive ad generation framework.

The collection of ad templates is generally designed to account for the spectrum of ad design options that would be appropriate for the particular ad objective. For example, the collection of ad templates can be used to specify various combinations of font styles, background graphics, scene/slide layouts, scene/slide transitions, etc. Through the display of the plurality of preview ads, the user can simply survey the various options and select the ad that is most suitable for the intended advertising campaign.

In one embodiment, the collection of ad templates or ads to be produced is selected based upon ad performance data. More specifically, the collection of ad templates or ads to be produced can be selected based upon the known relative success in generating significant user response. This feedback process would ensure that the user is presented with a set of candidate online ads that are most likely to succeed in the marketplace.

It is a feature of the present invention that the user need not specify the entire set of specific design parameters for the online ad. As described in the first embodiment, the user is called upon to specify the font, size, style, and color characteristics of individual textual elements and the types of transitions between slides. These low-level design specifications would hinder the user in creating a seamless, professional-grade online ad.

As the user does not typically possess any expertise in graphic ad design, the user in the second embodiment is called upon to simply direct the creation of the ad. No particular expertise in graphic ad design is thereby required. A user can specify an ad objective and the corresponding core content without having to consider the host of design parameters that are necessary to create a single viewable ad. By relying on a collection of predefined ad templates that are associated with the ad objectives, ad creation time is reduced while the quality of the resulting online ad is increased. These factors serve to greatly increase user satisfaction in the generated online ad and the corresponding advertising results.

As noted, the ad templates are populated with user-provided ad data. In one embodiment, the ad templates can be further populated based upon the intended focus of the ad. For example, if the user specifies an ad objective category (or sub-category) that relates to a particular industry or season of the year, then the ad template can include data (e.g., graphics related to the holiday season) that is related to the ad objective. As would be appreciated by one of ordinary skill in the relevant art, the specific elements of the ad template that are selectively imported are implementation dependent.

In one embodiment, the online ads are created as Macromedia™ Flash ads. An authoring environment of Macromedia™ Flash is used to create Macromedia™ Generator templates. When run, the Macromedia™ Generator templates would incorporate content from a data source. As would be appreciated, the principles of the present invention can also be used in generating online ads in different formats (e.g., animated GIFs, JavaScript, Java, etc.).

After the user has selected an ad using the associated radio button (e.g., radio button 1910), the user is then presented with ad confirmation screen 2000. Ad confirmation screen 2000 enables the user to review the ad for accuracy. For example, the user can click on the ad to ensure that the click action is operating in accordance with the user's direction. If the user determines that the ad is not satisfactory, then the user can proceed back through the ad creation process using the “back” button.

If the user determines that the ad is satisfactory, then the user can then proceed to schedule the ad using the “schedule ad” button. Ad scheduling can be performed in accordance with the process described above. Once scheduled, the online ad can be launched on the ad-serving network.

As described, the online ad creation process of the second embodiment enables users to realize an effective online ad without being involved in the specifics and complexity of the ad design process. The simplicity of the ad creation process serves to reduce the ad creation time. Significantly, the simplification of the ad creation process also serves to increase the quality of the generated online ad. With the present invention, users can generate seamless, professional-grade online advertisement at a fraction of the cost of employing professional graphic online ad designers. Indeed, the appearance of the generated online ad would suggest that it was built by a professional ad agency. In accordance with the principles of the present invention, the user need not have any expertise in web advertising design to create an effective online ad campaign.

While the invention has been described in detail and with reference to specific embodiments thereof, it will be apparent to one skilled in the art that various changes and modifications can be made therein without departing from the spirit and scope thereof. Thus, it is intended that the present invention cover the modifications and variations of this invention provided they come within the scope of the appended claims and their equivalents.

What is claimed is:

1. An online advertising method, comprising:
(a) receiving first information from a user, said first information being used to identify an objective of an advertising campaign;
(b) generating one or more candidate online ads using said objective and advertising content that is received from said user; and
(d) transmitting second information to a user computer, said second information enabling said user computer to display said one or more candidate online ads.

2. The online advertising method of claim 1, further comprising the step of querying said user for a set of advertising content, said set of advertising content being identified based at least in part upon said identified objective of said advertising campaign.

3. The online advertising method of claim 1, wherein said generating includes selecting advertising content from a set of advertising content that is received from said user.

4. The online advertising method of claim 1, wherein said generating includes identifying one or more templates that are associated with said identified objective.

5. The online advertising method of claim 1, wherein said generating includes generating a plurality of candidate online ads.

6. The online advertising method of claim 1, further comprising receiving third information from said user, said third information being used to identify a selection of a candidate online ad.

7. The online advertising method of claim 1, further comprising determining, in accordance with said identified objective, which portions of said advertising content to emphasize in said online ad.

8. The online advertising method of claim 1, wherein said online ad is a banner ad.

9. An online advertising system, comprising:
a processing system that enables a rendering of a user interface at a user computer, said user interface being configured to enable a user to define advertising information that includes advertising content and an indication of an advertising objective, wherein said user interface is further configured to display one or more candidate online ads that includes at least part of said advertising content, wherein said advertising content is displayed in said one or more candidate online ads in accordance with an advertising scheme that is defined at least in part by said processing system to satisfy said advertising objective.

10. The online advertising system of claim 9, wherein said processing system generates a plurality of candidate online ads.

11. The online advertising system of claim 10, wherein said user interface enables a user to select from said plurality of candidate online ads.

12. The online advertising system of claim 9, wherein said processing system generates online ads using ad templates.

13. The online advertising system of claim 12, wherein said processing system generates online ads using Macromedia Generator templates.

14. The online advertising system of claim 12, wherein said online ad is a banner ad.

15. The online advertising system of claim 9, wherein said processing system queries said user for a set of advertising content, said set of advertising content being identified based at least in part upon said identified objective of said advertising campaign.

16. The online advertising system of claim 9, wherein said processing system selects advertising content from a set of advertising content that is received from said user.

17. The online advertising system of claim 9, wherein said processing system identifies one or more templates that are associated with said identified purpose.

18. The online advertising system of claim 9, wherein said processing system generates a plurality of candidate online ads.

19. The online advertising system of claim 9, wherein said processing system receives a selection of a candidate online ad from said user.

20. The online advertising system of claim 9, wherein said processing system determines, in accordance with said identified objective, which portions of said advertising content to emphasize in said online ad.
